(19) United States
(12) Patent Application Publication
(10) Pub. No.: US 2002/0176116 A1
(43) Pub. Date: Nov. 28, 2002

(54) Digital watermarks as a communication channel in documents for controlling document processing devices

(76) Inventors: Geoffrey B. Rhoads, West Linn, OR (US); Philip R. Patterson, Sherwood, OR (US); Ronald S. Miolla, Wilsonville, OR (US)

Correspondence Address: DIGIMARC CORPORATION, 19801 SW 72ND AVENUE, SUITE 100, TUALATIN, OR, 97062, US

(21) Appl. No.: 10/121,434

(22) Filed: Apr. 11, 2002

Related U.S. Application Data
(60) Provisional application No. 60/283,736, filed on Apr. 12, 2001.

(51) Int. Cl. H04N 1/00

(52) U.S. Cl. 358/405

(57) ABSTRACT

Digital watermarks are embedded in documents to create a communication channel between document handling devices such as copiers, printers, scanners and fax machines. The digital watermarks are used to control document reproduction and transmission operations. The digital watermarks are also used to embed transaction information in documents, to link the document to an original, electronic version stored on a network, to trace the document handling history of a document, etc.

### TECHNICAL FIELD

The present application claims benefit of provisional application No. 60/283,736, filed Apr. 12, 2001, which is hereby incorporated by reference.

### BACKGROUND AND SUMMARY

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in a variety of media signals are detailed in the assignee's co-pending application Ser. No. 09/503,881 and U.S. Pat. No. 6,122,403, which are hereby incorporated by reference. Also, digital watermark techniques for hiding and detecting auxiliary data in documents and line art images are disclosed in: U.S. application Ser. No. 09/074,034, filed May 6, 1998 (which corresponds to PCT application PCT/US99/08252), and U.S. application Ser. No. 09/127,502, filed Jul. 31, 1998 (which corresponds to PCT application PCT/US99/14532), which are hereby incorporated by reference. Finally, digital watermark techniques for hiding auxiliary data in halftone images, including documents, are disclosed in U.S. applications Ser. No. 09/689,226, filed Oct. 11, 2000 by Hugh Brunk, and No. 60/263,987, filed Jan. 24, 2001 by Mark Haynes, which are hereby incorporated by reference.

Digital watermarks can be used for a variety of applications, including embedding information about a media object in the object, embedding usage or rendering control information in the media object, and embedding a pointer to a database that stores such information about the media object, to name a few. Several applications of digital watermarks are detailed in U.S. patent application Ser. No. 09/571,422, filed May 15, 2000, which is also incorporated by reference.

This disclosure describes systems and methods for using digital watermarks in documents to control handling of the documents in imaging devices, including copiers, scanners, printers and fax machines.

### BRIEF DESCRIPTION OF THE DRAWING

FIG. 1 is a system diagram illustrating document handling devices with digital watermark embedder and reader functions.

### DETAILED DESCRIPTION

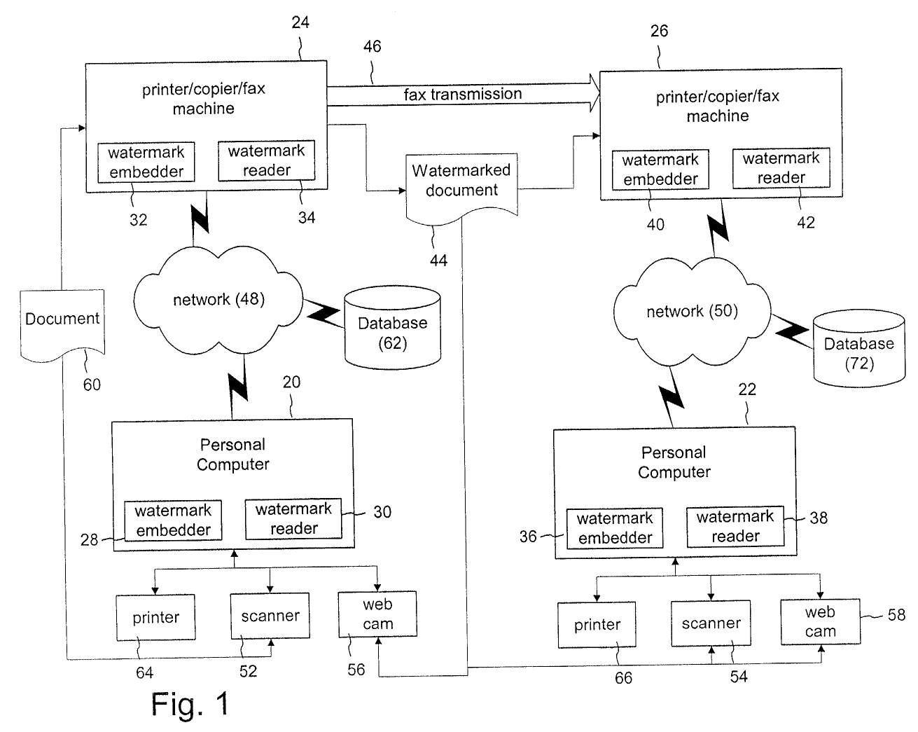

The following disclosure describes systems and methods for controlling the operation of document handling devices through digital watermarks embedded in documents. FIG. 1 is a system diagram illustrating document handling devices with digital watermark embedder and reader functions. Devices in the system, such as the personal computers 20/22, and printer/copier/fax machines 24, 26 include a watermark embedder and/or reader (28-42). The device labeled “printer/copier/fax machine” corresponds to one or more of the following devices: a printer, copier, or fax machine. For example, the device may be a stand alone printer, copier or fax machine. Alternatively, it may be a multi-function device such as copier/printer, copier/printer/fax machine, copier/printer/fax machine/document scanner, etc.

The watermark embedders embed an auxiliary message into a document by, for example, using one of the following processes:

1. Creating a watermarked image tile that forms a subtle background tint in the document. This watermarked tile may be created by error correction encoding a multi-bit message (convolution coding, turbo coding, BCH, Reed Solomon), spread spectrum modulating the error correction encoded message with a pseudo random carrier signal to form a spread spectrum modulated signal, and mapping the spread spectrum modulated signal to pixel locations in an image tile to form a watermark signal. The tile is a rectangular array of image pixels. It is replicated (e.g., tiled) contiguously across a page of a watermarked document. The pseudo random carrier signal may be generated by a pseudo random number generator seeded from a private or public key number. The spread spectrum modulation may be carried out in the spatial or frequency domain by exclusive ORing, multiplying, or convolving the multi-bit message with the carrier signal.

For more information on creating watermark signals, see U.S. patent application Ser. No. 09/503,881 or U.S. Pat. No. 6,122,403.

2. Modulating an image of text on a document by using line width modulation of the text as disclosed in U.S. application Ser. No. 09/074,034 (which corresponds to PCT application PCT/US99/08252), and U.S. application Ser. No. 09/127,502 (which corresponds to PCT application PCT/US99/14532. In this approach, a similar spread spectrum modulated signal may be used to modulate the width of line structures in the document to be marked.

3. Modulating a halftone image by using the methods disclosed in U.S. applications 09/689,226, filed Oct. 11, 2000 by Hugh Brunk, and No. 60/263,987, filed Jan. 24, 2001 by Mark Haynes. The halftone dot elements are modulated with the spread spectrum modulated signal.

The methods in items 1, 2 and 3 are particular useful when the document is converted to a rasterized form for printing. In rasterized form, the document pages are typically represented as line art or halftone images. In these types of images, the document is represented as an array of binary pixel states or dots representing either the presence or absence of an ink dot at a corresponding location on the page. In the first method, the watermark signal forms a background tint over which the document image, such as the image of text characters is superimposed. In the second and third methods, the watermark signal is embedded by modulating the rasterized image of the document with the watermark signal.

Each of the techniques may be designed to modulate the luminance of the image of the document according to the spread spectrum modulated signal. For example, in one implementation of the first method, the background tint varies the luminance of the background pixels (e.g., those not covered with text) such that the luminance of those pixels correspond to the values of corresponding elements in the spread spectrum modulated signal. In particular, the spread spectrum modulated signal constitutes an array of pixels that vary in luminance. The second method varies the line width of line art to vary the tonal density according to the spread spectrum modulated signal. The third method controls the halftone dot patterns to modulate the luminance of the resulting image according to the spread spectrum modulated signal.

Other methods for imperceptibly embedding information in documents may be employed as well, such as character, word or line shifting of text, etc. Also, the spread spectrum modulated signal may be computed by modulating coefficients of the background tint or document image in a frequency domain, such as the wavelet, Fourier, or DCT domain. The digital watermark may be hidden in a graphic, logo, or picture on part of the document surface. The information hidden in the digital watermark may be varied by changing the message payload and/or by changing the number, location and type (e.g., signals hidden in text, transform domain, spatial domain, etc.) of the digital watermarks embedded in the document. Document handling devices may then be designed to respond to one or more of these hidden signal types, and provide different responses based on different combinations of watermark message payloads, watermark type, watermark locations, and the number of watermarks detected.

The output of the watermark embedders is a watermarked document image. This image may be printed to create a hard copy of the watermarked document 44. Alternatively, the watermarked document image may be transmitted electronically, such as via fax transmission 46, or via electronic file transfer between devices on a computer network 48, 50, using conventional network communication protocols. In each of the above embedding techniques, the watermark signal tiles are spread across one or more pages of the document and do not interfere with the information on that document. Instead, the watermark signal alters the image subtly and substantially imperceptibly such the document can still be read and interpreted as if it were unaltered.

The watermark readers (30, 34, 38, 42) employ watermark detection and message decoding schemes to extract the message embedded in a watermarked document image. Methods for detecting and decoding digital watermarks are detailed in the patent documents referenced above. One detection approach is to correlate the document image with the spread spectrum carrier signal corresponding to each error correction encoded bit in a tile to generate estimates for that bit. All of the estimates for a particular error correction encoded bit in a tile are summed to form a weighted estimate. Error correction decoding is then applied to all of the weighted bit estimates to recover the original message. The recovered message may include error detection bits, such as a CRC, to validate the accuracy of the decoded message.

The watermark signal preferably includes attributes that enable the watermark reader to compensate for geometric distortion of the image when presented to a web cam, scanner, or other device. For example, the watermark signal has attributes that form peaks or other characteristic pattern in a transform domain of the image, such as the Fourier or autocorrelation domain. To compensate for affine transformations, the reader detects these peaks and correlates them with reference peaks to determine the affine distortion parameters (e.g., rotation, scale and translation). The reader then aligns the image using these distortion parameters and decodes the error correction encoded message from the aligned image data.

Preferably, as in the methods referred to above, the digital watermark signal embedded in the watermarked document 44 is readable from digital images captured from both image scanner and digital camera technology (such as scanner 52, 54 or web cam 56, 58 peripherals for computers and scanners in copiers and fax machines). The digital watermark is embeddable and readable by both hardware (embedded processors) and software (e.g., printer, scanner, fax machine device drivers, document editing programs, etc). The watermark embedders and readers are implemented in software applications (e.g., applications that run on personal computers 20, 22), operating systems and device drivers, and within hardware devices (e.g., printer, copier, fax machines 24, 26).

The watermark message embedded in a document image tile includes metadata such as control instructions and/or an index to a database 62, 72 that stores this metadata. The metadata database 62 is accessible via the watermark embedder and reader applications. In particular, it is either stored locally in memory in the same device as the watermark embedder/reader, or it is stored on a remote device accessible via a conventional wire, or wireless connection, such as a TCP/IP or WAP connection. The embedder creates a database entry and stores control information associated with the document in this entry when it embeds the watermark in the document. The reader accesses the data base to look up related instructions or information.

To illustrate the flow of operation, consider an example shown in FIG. 1. To start, an electronic document is created in the personal computer or captured from a physical document 60 in a scanner (e.g., scanner 52, or a scanner embedded in a copy machine or fax machine 24). When a document is created in a word processor, for example, the document includes a collection of text and possible graphics and images. The text, graphics, and images are rasterized into a printable image. Next, a watermark embedder (e.g., a software application or device driver 28 in the PC 20, or software/firmware 32 in the copy/fax machine 24) embeds the watermark in the rasterized image of the document. In alternative implementations, text based watermarks that embed data by adding or deleting spaces, lines, etc. may be used to encode auxiliary information in text before it gets rasterized into an image.

During the embedding process, the watermark embedder may communicate with a database 62 to record the document index along with the metadata associated with the document. Finally, the rasterized document is printed to form a watermarked document 44 using a printer (e.g., networked printer 24, or printer 64 connected to PC). The rasterized document may be transmitted electronically via fax transmission 46 or network file transfer through the network 48 before being printed on a remote device (e.g., fax machine 26, printer 66).

At various points in the communication path of the watermarked document, the watermark readers in devices along that path decode the message embedded in the watermark and act upon it. This action may include executing instructions embedded in the watermark, and/or using the watermark message data to index instructions stored in the database 62, 72. In the latter case, the watermark reader establishes a connection with the database management system 62, 72, such as through a TCP/IP connection.

The watermark in the document enables document handling devices to communicate via messages embedded in the document. The watermark embedded in the document forms a communication channel that survives when the document is printed and re-scanned. The watermark message may be used to embed control instructions that instruct watermark reader enabled devices, such as fax machines and copiers, how to process the document. These instructions may include special print or copy instructions, such as informing the receiving fax machine device that the document contains text and/or graphics, instructions for sending (or not sending) faxes of the watermarked document to a location or list of locations, and user specified instructions from the document sender or creator.

For example, the user may invoke the watermark embedder in a PC 20 to embed fax control information into the document before printing that document. Later, when faxing the document, the fax machine 24 detects the watermark and sends the fax automatically using the fax control information in the document. This embedded information avoids the need for the sender to enter this information in the fax machine. For example, the sender does not have to manually enter the fax number because the fax machine has a watermark reader that extracts the number from the digital watermark embedded in the document. If the message payload of the watermark is insufficient to carry the fax instructions and phone number, the payload can carry an index to a database entry that stores the fax instruction and phone number. In this case, the reader extracts the index, sends it to the database (e.g., database 62 networked to the device), which returns the fax instructions and phone number or numbers (e.g., phone numbers for a broadcast fax).

The database 62 of document control information can be distributed such that copies of the database entries are replicated in the memories of other devices or networks. For example, in FIG. 1, a database 62 that serves document handling devices (e.g., 20 and 24) at one location, can be replicated at other locations, such as the database 72 that serves document handling devices 22 and 26 at another location. Specifically, the two databases 62, 72 share information via a network connection between the two networks 48 and 50 on which they reside. This enables watermark enabled devices at both locations to access the database of instructions and process physical documents that pass between the two locations using the same document control information.

The watermark message in the original document can include the number of copies to create from an original. Also, the watermark message may be used to control reproduction of certain pages of that document. For example, the watermark message may include an instruction to the reproduction device (copier or fax machine) indicating whether or not to reproduce a specific page in a multi-page document. For example, the watermark in the document may include or link to an instruction indicating that page 3 of the document contains “sensitive” graphics and should not be reproduced as part of the report reproduction.

The watermark may be used to stamp pages sent via fax machine for legal considerations. This could be used as proof that the fax was sent. Relevant data in the watermark message could include:

1. Date and time the fax was sent.

2. The fax number the fax was sent from.

3. The fax location identifier the fax was sent from.

4. The fax number the fax was sent to.

5. The fax location identifier the fax was sent to.

6. An identifier unique to the sending fax machine such as the serial number.

7. Additional information such as the make, model, manufacture date and the EPROM version might be useful.

Any compatible watermark reader can then extract this information and display it, or use this information to control processing of the document.

The watermark message may also control the reproduction or distribution of a “page” in a document in which that message is embedded. Some example control instructions include:

1. Internal use only

2. Allowed “outside” a defined group of devices.

These instructions define a class of devices, such as devices with particular ID, that are authorized to reproduce the document. The watermark reader interprets these instructions and controls reproduction of the document depending on whether the device in which the document is being re-produced or faxed is a member of the allowed group.

The watermark message in one page of a document may be used to control (re)production of a document set from any 1 page in the document.

The watermark message embedded in a hard copy document may also carry a pointer or network address to its electronic “original” or to the most recent version. For example, the pointer may point to a database entry in the database 62,72 where the original is stored. The original may be stored as a rasterized image, or as a word processing document, presentation, spreadsheet or database that is editable using a corresponding word processing, presentation, spreadsheet or database program. As another example, the pointer may be a URL or IP address of the document or editable document file on a network. This facilitates the reduction in space required to retain copies of “the same” document.

The watermark message embedded in a document may also be used to trace the “lineage” of a printed/copied/faxed document. For example, each time a document is processed by a device with a watermark reader, the watermark reader updates a database entry for the document, indexed by an ID in the watermark. For each processing event, the reader indicates the type of event and other transactional information, such as the device ID of the device that processes the document, the user ID of the user that processed the document, etc.

The watermark message embedded in a document may be used to assist in determining if a document has been altered. For example, the watermark reader evaluates the watermark signal tiles spread throughout the document to determine whether the document has been altered. If the document has been altered in a particular image tile, the watermark reader is likely to encounter errors in decoding the message from that tile. A measure of the error is used to determine whether the document has been altered in that tile. For example, the following process can be used based on a convolution coding scheme for error correction coding:

1. Use the payload read from the watermark to re-create the original embedded bit sequence (including redundant bits) used for the watermark.

2. Convert the original bit sequence so that a zero is represented by −1 and a one is represented by 1.

3. Multiply (element-wise) the soft-valued bit sequence detected in the watermark decoding process by the sequence of step 1.

4. Create two measures of watermark strength from the sequence resulting in the previous step. The first measure is the sum of the squares of the values in the sequence. The second measure is the square of the sum of the values in the sequence.

5. Compare the strength measures to thresholds to decide if the suspect tile in the document has been altered.

This is just one example of using the watermark signal for detecting document alteration. In some cases, the watermark may not be detectable at all in one or more tiles. In this case, the document can be considered to be altered. The watermark signal can be designed to allocate one or more bits of the message to certain spatial frequencies within the tile. Bits allocated to higher spatial frequencies are more likely to be distorted when the document is scanned using lower resolution scanning and/or printing devices that cause distortion or aliasing at certain spatial frequencies. The above technique can be used to measure bit errors at selected frequency ranges to detect alteration by photocopying, or scanning and re-printing.

This method may be used to detect whether a document has been altered relative to is original printed version at a copy station, or relative to its original faxed version at a fax station.

The watermark tile may include both robust and fragile portions. For example, robust information may be redundantly encoded into low frequency components of the watermark signal, while fragile information may be encoded at higher frequency components. The fragile component of the watermark signal is then used in the watermark reader to detect alteration or unauthorized copying, while the robust watermark is used to carry payload information such as document control instructions or an index to a database storing an original of the document and other related control instructions or metadata.

The watermark message embedded in a document may also be used to control functions of the fax machine receiving the document. For example, when the receiving fax machine gets the document, it invokes a watermark reader to decode any embedded watermarks in the document and process the instruction or instructions in those watermarks. For example, the watermark instructions can specify whether or not the receiving fax machine should acknowledge receipt of an incoming document or allow it to be received at all.

Concluding Remarks

Having described and illustrated the principles of the technology with reference to specific implementations, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

we claim:

1. A document carrying a document control instruction in a digital watermark signal embedded on the document, the document control instruction including an instruction for controlling fax transmission or reproduction of the document.

2. The document of claim 1 wherein the digital watermark comprises a spread spectrum modulated image signal embedded in a document image on one or more pages of the document.

3. The document of claim 2 wherein the spread spectrum modulated signal is a background tint over which information content of the document is superimposed.

4. The document of claim 3 wherein the information content includes text characters that are superimposed over the background tint.

5. The document of claim 3 wherein the spread spectrum modulated signal is embedded in the document by modulating line widths in a rasterized version of text content of the document.

6. The document of claim 3 wherein the spread spectrum modulated signal is embedded in the document by modulating half tone dots to create variations in luminosity of the document in accordance with the spread spectrum modulated signal.

7. The document of claim 1 wherein the instruction includes a fax control instruction to instruct a fax machine to send the document to a particular destination.

8. The document of claim 1 wherein the instruction includes a reproduction control instruction that controls re-production of a designated portion of the document.

9. The document of claim 1 wherein the instruction specifies a group of users or devices that are allowed to reproduce the document.

10. The document of claim 1 wherein the instruction specifies a group of users or devices that are allowed to receive a fax transmission of the document.

11. The document of claim 1 wherein the instruction includes an index to a memory location where an original, electronic version of the document is stored.

12. A fax machine including a digital watermark embedder for combining a rasterized version of a document with a digital watermark signal, the digital watermark recording transaction information about a fax transmission of the document.

13. The fax machine of claim 12 wherein the transaction information includes a time stamp of the fax transmission.

14. The fax machine of claim 12 wherein the transaction information includes information about an origination address or destination address of the fax transmission.

15. A document reproduction device including a digital watermark embedder for combining a rasterized version of a document with a digital watermark signal, the digital watermark including an instruction that limits reproduction of some or all of the document to a predetermined group of devices or users.

16. The document reproduction device of claim 15 wherein the instruction includes an index to a database that lists devices or users that are authorized to reproduce the document.

17. A document processing device including a digital watermark reader for extracting a message payload embedded in a document and accessing a database entry to record a transaction event to track reproduction or faxing of the document.

18. The document of claim 1 wherein the instruction is operable to instruct a fax machine receiving the document to acknowledge receipt of the document to a sending fax machine.

19. The document of claim 1 wherein the digital watermark is operable to indicate whether the document has been altered by measuring strength of the watermark signal.

20. The document of claim 19 wherein the strength of the watermark signal is measured by measuring bit errors of an error correction encoded message embedded in the watermark.

21. The document of claim 19 wherein the watermark is replicated in tiles spread over the document, and detection of the watermark tiles enables location of one or more altered parts of the document to be identified.

22. The document of claim 19 wherein the digital watermark includes a fragile component that degrades in response to alteration of the document and a robust component embedded more robustly than the fragile component for carrying the document control instruction.
